(19) United States
(12) Patent Application Publication
(10) Pub. No.: US 2022/0357711 A1
(43) Pub. Date: Nov. 10, 2022

(54) FIELD DEVICE

(71) Applicant: TURCK HOLDING GMBH, Halver (DE)

(72) Inventors: Friedrich Becker, Lemgo (DE); Hermann Schwagmann, Detmold (DE)

(21) Appl. No.: 17/624,268

(22) PCT Filed: Jul. 3, 2020
(86) PCT No.: PCT/EP2020/068762

§ 371 Date: Dec. 31, 2021

(30) Foreign Application Priority Data
Jul. 12, 2019 (DE) 10 2019 118 919.5

(51) Int. Cl. G05B 19/042

(52) U.S. Cl. CPC G05B 19/042; G05B 2219/25428

(57) ABSTRACT

A further field device is configured to interact with a field device having a storage device storing a configuration of at least the further field device. The field device is configured to output the configuration to the further field device and/or to receive the configuration from the further field device. The further field device is furthermore configured to receive and/or to store the configuration from the field device, in order to match the configuration received from the field device to its technical design.

### CROSS REFERENCE TO RELATED APPLICATIONS

This application is a U.S. National Phase application under 35 U.S.C. § 371 of International Application No. PCT/EP2020/068762, filed on Jul. 3, 2020, and claims benefit to German Patent Application No. DE 10 2019 118 919.5, filed on Jul. 12, 2019. The International Application was published in German on Jan. 21, 2021 as WO 2021/008894 A1 under PCT Article 21(2).

### FIELD

The present invention relates to a field device or a fieldbus device and a system comprising several field devices that can be interconnected.

### BACKGROUND

Due to current developments in automation engineering, which can be subsumed under the term Industry 4.0, some works now address distributing control tasks to decentralized nodes. The nodes have embedded systems which execute these control tasks in addition to their actual tasks.

In such field devices, it is therefore necessary, alongside a configuration of real-time systems, to also carry out an implementation of application-specific subprograms.

This configuration effort is crucial in the case of device replacement, in particular if this was caused by an unplanned device failure. This can lead to production downtimes, which are also associated with economic losses.

Real-time Ethernet solutions (e.g. PROFINET), which make a central automated configuration possible in the event of device replacement, are often not possible in this case as they are usually of a proprietary nature. Furthermore, in the case of a special application created for a user, a stand-alone compact controller is usually present, which must not be coupled to a central controller.

One approach that is often followed to avoid a manual configuration is therefore to store the latter on a memory card connected to the field device. In the event of device replacement, this is then plugged from the old field device into the new one.

A disadvantage of this approach recognized by the present invention is that the electronics for actuating the memory card require additional expenditure and installation space in the device. Furthermore, the approach does not work if the failure was caused by a fault associated with the memory card.

### SUMMARY

In an embodiment, the present disclosure provides a further field device configured to interact with a field device having a storage device storing a configuration of at least the further field device. The field device is configured to output the configuration to the further field device and/or to receive the configuration from the further field device. The further field device is furthermore configured to receive and/or to store the configuration from the field device, in order to match the configuration received from the field device to its technical design.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows two field devices; and

FIG. 2 schematically shows a system comprising several of the field devices represented in FIG. 1.

### DETAILED DESCRIPTION

Embodiments of the present invention provide a field device and a system comprising several field devices that can be interconnected, which overcome the disadvantage of the state of the art described above.

Accordingly, embodiments of the present invention provide a field device with a storage device which stores a configuration of a further field device, wherein the field device is designed to output the configuration to the further field device and/or to receive the configuration from the further field device.

This offers the advantage that the further field device need not be manually configured if it loses its configuration, for example in the case of a power outage or if a device is changed.

A field device can be a device which is designed to control and/or to monitor an actuator and/or a sensor. The field device can have an input interface and/or an output interface. The field device can be designed to communicate with further field devices in or over a network. The field device can be designed to communicate with the further field device and/or a control or management system via a fieldbus. The field device can be designed to communicate with the further field device and/or a control or management system via a real-time data connection. The real-time data connection can be a real-time Ethernet connection. The field device can be designed to output a current or actual state of a sensor and/or actuator connected thereto to the management system. The field device can be designed to receive a target state of a sensor and/or actuator connected to it from the management system, to process it and to output it to the sensor and/or actuator connected thereto. The field device can be designed, in the case of particular states that can optionally be preset, to send a notification to a management system.

It is conceivable that the field device is or has a controller, in particular a programmable logic controller (PLC). The field device can additionally or alternatively be or have a network switch or router. It is furthermore conceivable that the field device is realized as a part of a sensor or the sensor functions as a field device. This means that the sensor stores the configuration of the field device and/or of the further field device.

The storage device can be provided in or on the field device. The storage device can have a non-volatile memory, such as for example a read-only memory (ROM), a random-access memory (RAM), a programmable read-only memory (PROM), and/or an electrically erasable programmable read-only memory (EEPROM). The storage device can store data and programs for controlling and/or monitoring a sensor and/or actuator. The storage device can be connected to a central processing unit (CPU), which is arranged in or on the field device. The processing unit can be connected to an input and/or output interface of the field device. The processing unit can be designed to download programs stored in the storage device into a main memory and to execute the programs.

The configuration can enable a field device to start up. The configuration can comprise programs for controlling and/or monitoring a sensor and/or actuator. The further field device can have the same configuration as the field device or a different one. If a configuration is missing in a network to which it is connected, the further field device can be designed to search for the respective configuration. The configuration can comprise an operating system.

This solution offers, among other things, the advantage that in the case of a failure of individual hardware modules, i.e. field devices, a mostly lengthy and error-prone manual reconfiguration of the field device can be avoided.

In other words, the field device has a storage device which is designed to store a configuration of a further field device. The field device is designed to output the stored configuration to the further field device, and/or to receive the configuration from the further field device and to save the received configuration in the storage device.

The configuration of the further field device can be stored in a blockchain. A blockchain is a continuously expandable list of datasets or blocks, which are linked together by means of cryptographic methods. Each block can have a cryptographically secure hash or hash value of the previous block, a timestamp and/or transmission or received data, such as for example from or by which device and/or user the configuration originates, was received and/or saved. Storing the configuration in a blockchain offers the advantages that the configuration for restoring the further field device is actually provided for it, a possible manipulation of the configuration is recognized and it is ensured that the configuration comes from a trustworthy device, for example from the same network.

The field device can have an interface for a monitor and/or protocol function. The interface for the monitor and/or protocol function can enable the information stored in the field device to be read out. The monitor and/or protocol function can enable the storage of the configuration to be influenced, i.e. for example to set which configuration and/or which parts of the configuration are saved in the respective field device. Thus, for an operator, the possibility exists to control or to implement a distributed storage of the configuration over several field devices. The security can thus be increased in a complete system with several field devices. Via the interface information can thus be read out from or by the field device, which for example give some indication of performed and/or planned actions with regard to the distributed backup of the configuration. The interface can be designed such that it can be connected to a graphical user interface, e.g. a display of a maintenance device. The information output via the interface can comprise which further field device is storing the configuration, and optionally in which version, how many configurations are being stored by the further field device, and optionally in which version, and/or when a configuration was restored. The field device can be designed to log this information internally. The interface can also comprise an input function, with the result that stored information can be reset, altered and/or deleted.

The configuration can comprise a piece of firmware, a parameterization and/or another piece of software. The firmware here can be a piece of software which belongs to the hardware of the further field device, is filed by the manufacturer in a read-only memory and/or cannot be altered by the user. The parameterization can comprise input parameters for programs for controlling and/or monitoring a sensor and/or actuator. The other software can comprise programs for controlling and/or monitoring a sensor and/or actuator. This makes a decentralized storage of several or all files necessary for the configuration of the further field device possible.

An “object” (e.g. parameterization, programming or software), backed up in a decentralized manner, of a device does not require a separate identifier as to which type of “object” it is, as the “object” can be identified, for example, via a complete device ID. It is furthermore conceivable that a distinction is made according to the type of the “object”, with the result that different types of “objects” of a device can be backed up. This should optionally also be effected on different devices.

The device can be designed to store further information in addition to the configuration of the further device.

Not only can the configuration or a configuration blob of the further device be transmitted, it can also be subdivided into individual objects. The device and/or the further device can be based on an object structure which is filed in the device's own database. The objects to be backed up can be defined or predetermined. This has the advantage that in the case of a later expansion of an object model (e.g. new device firmware with additional properties) it is furthermore possible to restore the objects (of the old version of the device firmware). Compatibility can thus be achieved.

The field device can be designed to identify the further field device. The further field device can be the physical neighbor of the field device in a system with several field devices. The identification can be effected, for example, via LLDP. The LLDP (Link Layer Discovery Protocol) is a vendor-neutral layer 2 protocol, which is defined according to the IEEE-802.1AB standard and provides the opportunity to exchange information between neighboring devices. For this purpose, a software component can be provided on the field device, the so-called LLDP agent, which sends information about itself at periodic intervals and receives information from neighboring devices. The received information can be stored locally on the field device in a data structure, for example in the blockchain described above. Via the identification of the individual field devices it can be detected, in a network with several field devices, which field device has failed.

The field device can be designed to delete its configuration and/or the configuration of the further field device as soon as it is connected to a field device other than the further field device. The field device can be designed to encrypt its configuration and/or the configuration of the further field device as soon as it is connected to a field device other than the further field device. This offers the advantage that sensitive configurations which are stored on the field device cannot be read out if installed in a different environment. Thus a misuse of such information can be reliably prevented. The encryption can be effected, for example, using a password.

The field device can be designed to delete its configuration and/or the configuration of the further field device, or to encrypt its configuration and/or the configuration of the further field device if, during booting up, it is connected to a field device other than the further field device. If, therefore, the environment is the same during booting up of such a field device, the field device accepts the environment. If a change in the environment has taken place, a misuse of the information stored on the field device is thus reliably prevented.

The field device can be designed to match a stored configuration to the further field device. For this, the field device can have a piece of software stored which, after identification of the further field device connected to it, matches or individualizes a stored configuration to the specific requirements of the further field device connected to it. This also makes it possible not only to exchange identical or structurally identical field devices, but it is sufficient if the field devices are functionally interchangeable. This can mean both that a device with a greater functional range can replace one with a lesser functional range but also that a device with a lesser functional range can be used if the one currently used has a greater functional range but does not need it.

The field device can be designed to output its configuration to the further field device. In a preferred embodiment, an operator can prevent the configuration from being output to the further field device. The backup function in the field devices can accordingly be selectively switched off, with the result that in particular sensitive or confidential configurations cannot be copied and backed up arbitrarily in the system. It is also conceivable that only a particular circle of further field devices is enabled to store the configuration of the field device.

Furthermore, a further field device is provided. The above statements relating to the field device also apply to the further field device, unless explicitly indicated otherwise. The further field device is designed to interact with the field device described above, i.e. to be able to exchange data, such as for example a configuration, at least unidirectionally. The further field device can furthermore be designed to output its configuration to the field device (1, 2, 3, 4), but not to receive and/or to store any configurations of the field device (1, 2, 3, 4) itself. However, it is also possible for the further field device to be designed to receive and/or to store a (any desired) configuration from the field device (1, 2, 3, 4), in order to match the received configuration (itself) to its (own) technical design.

This means that the storing field device matches the configuration to the further field device (i.e. for example a replacement device). This can be effected before sending the matched configuration to the further field device. For this the storing field device requires information about the properties of the original device and of the replacement device, in order to be able to perform the matching. An operator can for example enter this information into the field device and/or the field device can receive this information from the replacement device. In the latter case, it may be sufficient for the replacement device to send only one item of information about its properties to the field device, as the field device can be designed to determine the properties of the original further field device on the basis of the stored configuration of the original further field device.

The second further variant offers the advantage that the field device that is backing up can send the original configuration in unaltered form to the further replacement device and the replacement device performs the matching of the configuration independently. This is because the replacement device knows its own technical capabilities in any case and the information exchange described above may become superfluous.

Furthermore, a system with several field devices of the type described above that can be interconnected is provided. Several means at least two field devices.

In the system, a configuration of one of the field devices can be stored on several further field devices. A stand-alone reconfiguration can thus take place between the field devices even if several field devices fail.

The configuration of the one of the field devices can be stored fragmented on the several further field devices. Fragmented means that the entire configuration of the one field device is not stored on one of the several further field devices, but that the configuration is stored in each case in several parts that correspond to one another on the several further field devices. In other words, the configuration of the one field device is stored distributed over several field devices. This can preferably be the case when a storage capacity of an individual field device is not sufficient to store the entire configuration.

The system can have one field device functioning as the central instance, which is designed to store several configurations of further field devices and to output the several configurations in each case to them. A field device with high capacity compared with the other field devices, such as for example high storage capacity, can be used for the field device functioning as the central instance. The field device functioning as the central instance can have a further dedicated function in addition to its storage function. In a preferred embodiment, the field device can be designed to output the configurations simultaneously, with the result that it is possible to quickly restart the system if several field devices fail.

The field device on which the configuration of the further field device is stored can be a field device that is not directly adjacent. Directly adjacent can mean that no other field device is physically arranged between the respective field devices. Field devices can be directly adjacent if a third field device does not intersect a direct straight connecting line from one field device to the further field device. This offers the advantage that, in the event of damage, there is a reduced risk that the field device on which the configuration to restore the further field device is stored is also affected.

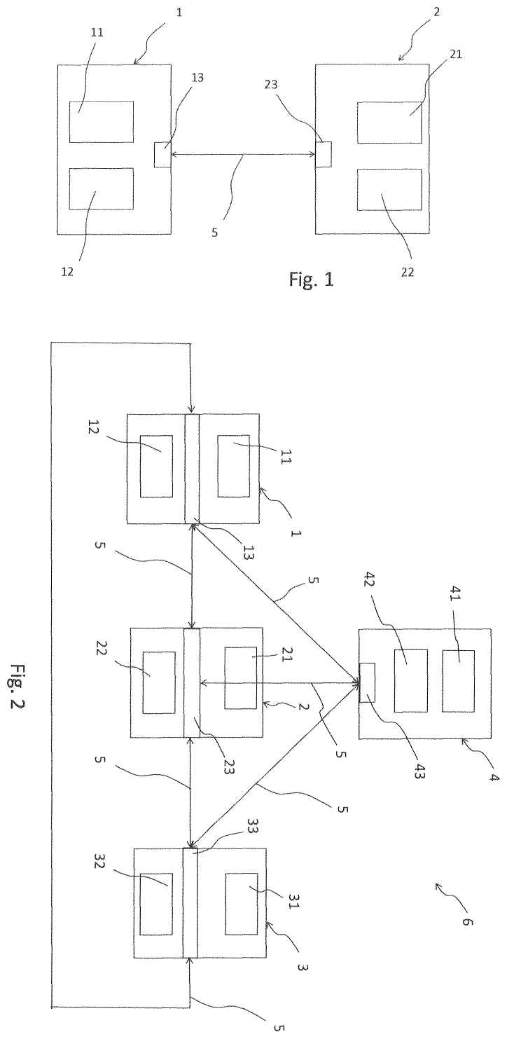

Two field devices, i.e. a first field device 1 and a second field device 2, are schematically represented in FIG. 1. Each field device 1, 2 has in each case a storage device 11, 21, a CPU 12, 22 and an in-/output interface 13, 23. The two field devices 1, 2 are connected via a data connection 5, which can be implemented both wirelessly and wired.

The first and the second field device can be structurally identical or can differ from each other in their size, computing power and/or computing capacity.

The first field device 1 outputs its configuration, stored in the memory 11, controlled by the CPU 12, by means of the data connection 5 to the second field device 2 via the in-/output interface 13.

The second field device 2 receives the configuration of the first field device 1 via its in-/output interface 23 and stores the received configuration in its memory 21 in a blockchain controlled by the CPU 22. The configuration here can comprise a piece of firmware, a parameterization and/or another piece of software.

The second field device 2 is furthermore designed to identify the first field device 1. This can take place for example on the basis of the configuration received from the first field device 1. More precisely, the second field device 2 can be designed to determine a design of the first field device 1, controlled by its CPU 22, on the basis of the configuration received from the first field device 1 and to save this information together with its configuration.

The second field device can furthermore be designed to receive further information in addition to the configuration of the first field device 1 via its in-/output interface 23 and to store it in its memory 21 together with the configuration of the first field device 1. For example, the first field device 1 can transmit, in addition to its configuration, its identification in a system with several field devices described later, its position in the system and/or information about which configurations of further field devices it has stored in its memory 11.

An operator (not represented) can read out the information stored in the memory 21 of the second field device 2 via the in-/output interface 23, which also functions as an interface for a monitor and/or protocol function.

The above description of course also applies to the opposite case, in which the second field device 2 transmits its configuration to the first field device 1. This transmission can then be effected simultaneously with or at the same time as the above-described transmission from the first to the second field device 1, 2 or the configurations can be exchanged sequentially between the field devices 1, 2. The configurations can be transmitted between the field devices 1, 2 periodically during operation, with the result that the field devices 1, 2 always have the current configuration of the respectively other field device 1, 2 saved.

Furthermore, the first and the second field device 1, 2 each have a security function. This security function allows the field devices 1, 2 to delete their configuration and/or the configuration of the other field device 1, 2 as soon as they are connected to a field device other than the first or second field device 1, 2, respectively. More precisely, the field device 1, 2 recognizes, as described above, which field device 1, 2 it is currently connected to. If one of the field devices 1, 2 is separated from the respectively other field device 1, 2 and introduced into a new system of field devices, it deletes the stored configurations, for example during booting up. Alternatively, it can also encrypt its configuration and/or the configuration of the further field device.

Furthermore, the field devices 1, 2 are designed to match a configuration already stored in their memory 11, 21 to the respectively other field device 1, 2. Here, for example when one field device in a system with several field devices is exchanged, the field device 1, 2 recognizes on the basis of the configuration transmitted by the new field device which type of field device this new one is. Through information stored in its memory 11, 21 it matches or adapts the stored configuration of the field device 1, 2 previously connected to it to the new field device controlled by its CPU 12, 22.

The field device 1, 2 can furthermore have a further security function. It may be possible for it to be designed to receive a configuration from another field device 1, 2, but not to output its own configuration. This security function can be designed such that it can be selectively activated by an operator.

The field device 1, 2 can also be designed that it outputs its own configuration to a further field device 1, 2, but does not accept and/or store any configurations of a further field device 1, 2. This may be sensible, for example, when the field device 1, 2 is located in a physically less secure area (e.g. in the outdoor/outside area of a plant) and no sensitive configurations of further field devices 1, 2 are to be stored in this area.

A system 6 with several, here four, interconnected field devices 1, 2, 3, 4 is described below with reference to FIG. 2.

The field devices, i.e. the first 1, the second 2, the third 3 and the fourth 4 field device, all have the configuration described above with reference to FIG. 1. Each field device 1, 2, 3, 4 thus has in each case a storage device 11, 21, 31, 41, a CPU 12, 22, 32, 42 and an in-/output interface 13, 23, 33, 43. The field devices 1, 2, 3, 4 are interconnected in each case via a data connection 5, which can be implemented both wirelessly and wired.

The first field device 1 is physically located directly adjacent to the second field device 2. The second field device 2 is physically located adjacent to the first and to the third field device 1, 3, thus between the first and the third field device 1, 3. The fourth field device 4 is arranged at a distance from the first, second and third field devices 1, 2, 3 which is greater than the respective distance between the first, second and third field devices 1, 2, 3.

In the exemplary embodiment of FIG. 2, each field device 1, 2, 3, 4 stores its own configuration in its memory 11, 21, 31, 41.

The configuration of the first field device 1 is additionally stored both on the third and on the fourth field device 3, 4, wherein either the entire configuration of the first field device 1 is in each case stored on the third and the fourth field device 3, 4 parts that complement each other are stored on them, i.e. there is a fragmentation of the configuration of the first field device 1.

The configuration of the second field device 2 is additionally stored on the fourth field device 4.

The configuration of the third field device 3 is additionally stored both on the first and on the fourth field device 1, 4, wherein either the entire configuration of the third field device 3 is in each case stored on the first and the fourth field device 1, 4 or parts that complement each other are stored on them, i.e. there is a fragmentation of the configuration of the third field device 3.

The configuration of the fourth field device 4 is only stored on the fourth field device 4 itself. As the fourth field device 4 stores the configuration of the other three field devices 1, 2, 3, its storage device 41 has larger dimensions than the storage devices 11, 21, 31 of the other three field devices 1, 2, 3.

In the system 6, a configuration of the first, the second and the third field devices 1, 2, 3 is therefore stored, possibly also fragmented, in at least one further, here the fourth, field device 4. In the system 6, the fourth field device 4 functions as the central instance, i.e. several configurations of further field devices, here of all further field devices 1, 2, 3, are stored thereon. The fourth field device 4 is designed to output the several configurations in each case to the first, second and third field device 1, 2, 3 in the event of a defect and/or an exchange. If several field devices are affected at the same time, thus e.g. the first and the second field device 1, 2, the fourth field device 4 is designed to output the respective configuration to the first and the second field device 1, 2 at the same time or simultaneously, with the result that the system 6 is operational again as quickly as possible.

Furthermore, the system 6 is constructed such that the configuration of the first and of the third field device 1, 3 is not saved in the second field device 2, i.e. the physically directly adjacent device in each case. Thus, even if a defect in an area in which both the first and the second field device 1, 2 are arranged, e.g. a local fire, the configuration of the first and of the second field device can be downloaded again from the third, still undamaged, field device 3. The same applies if the first, second and third field devices 1, 2, 3 are damaged. The respective configuration can then be downloaded from the field device 4 functioning as the central instance.

The field devices 1, 2, 3, 4 described above and the system 6 consequently offer the advantage that a production plant can be automatically put back into operation as quickly as possible without manual programming effort if one or more field devices fail.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

1, 2, 3, 4 field device

11, 21, 31, 41 memory

12, 22, 32, 42 CPU

13, 23, 33, 43 in-/output interface

5 data connection

6 system

1. A further field device configured to interact with a field device having a storage device storing a configuration of at least the further field device, wherein the field device is configured to output the configuration to the further field device and/or to receive the configuration from the further field device,
wherein the further field device is furthermore configured to receive and/or to store the configuration from the field device, in order to match the configuration received from the field device to its technical design.

2. The further field device according to claim 1, wherein the configuration is stored in a memory of the field device in a blockchain.

3. The further field device according to claim 1, wherein the field device has an interface for a monitor and/or a protocol function.

4. The further field device according to claim 1, wherein the configuration comprises a piece of firmware, a parameterization and/or another piece of software.

5. The further field device according to claim 1, wherein the field device is configured to store further information in addition to the configuration of the further field device.

6. The further field device according to claim 1, wherein the field device is configured to identify the further field device.

7. The further field device according to claim 1, wherein the field device is configured to delete the configuration and/or a configuration of the further field device, or to encrypt the configuration and/or a configuration of the further field device as soon as the field device is connected to a field device other than the further field device.

8. The field device according to claim 1, wherein the field device is configured to delete the configuration and/or a configuration of the further field device, or to encrypt the configuration and/or a configuration of the further field device if the field device is connected to a field device other than the further field device during booting up.

9. The field device according to claim 1, wherein the field device is configured to match the configuration stored in the field device to the further field device.

10. The field device according to claim 1, wherein the field device is configured to output the configuration to the further field device, wherein an operator can prevent the configuration from being output to the further field device.

11. (canceled)

12. The system according to claim 16, wherein an additional configuration of one of the several field devices is stored on one of the several further field devices.

13. The system according to claim 16, wherein the additional configuration of the one of the several field devices is stored fragmented on a further field device of the several field devices.

14. The system according to claim 16, with a field device of the several field devices which functions as a central instance and is configured to store several configurations of further field devices and to output the several configurations in each case to them, simultaneously.

15. The system according to claim 16, wherein the field device on which the configuration of the further field device is stored is not a directly adjacent field device.

16. A system of several field devices, the several field devices comprising at least a field device and a further field device, the further field device configured to interact with the field device having a storage device storing a configuration of at least the further field device, wherein the field device is configured to output the configuration to the further field device and/or to receive the configuration from the further field device,
wherein the further field device is furthermore configured to receive and/or to store the configuration from the field device, in order to match the configuration received from the field device to its technical design, and
wherein the several field devices can be interconnected.

17. A method for configuring field devices, comprising:
providing a further field device;
providing a field device having a storage device storing a configuration of at least the further field device;
interacting, by the further field device, with the field device,
outputting the configuration, by the field device, to the further field device; and
receiving and/or storing, by the further field device, the configuration from the field device, in order to match the configuration received from the field device to its technical design.
